(19) United States
(12) Patent Application Publication
(10) Pub. No.: US 2008/0163896 A1
(43) Pub. Date: Jul. 10, 2008

(54) DEVICE FOR PREPARATION AND DISPENSING OF BEVERAGES, WITH CLEANING DEVICE

(75) Inventor: Matteo Ioannone, Steinmaur (CH)

Correspondence Address: PEPPER HAMILTON LLP, ONE MELLON CENTER, 50TH FLOOR, 500 GRANT STREET, PITTSBURGH, PA, 15219, US

(73) Assignee: NIRO-PLAN AG, Aarburg (CH)

(21) Appl. No.: 11/870,912

(22) Filed: Oct. 11, 2007

(30) Foreign Application Priority Data
Oct. 11, 2006 (DE) 10 2006 047 969.6

(51) Int. Cl. B08B 3/00

(52) U.S. Cl. 134/18; 134/133

(57) ABSTRACT

The invention concerns a device for preparation and dispensing of beverages with a mechanism for initiating and carrying out a cleaning process. The device consists of at least one line, serving to transport the beverages to a beverage outlet and means for adding a cleaner for at least partial cleaning of the at least one line and means for recognizing the dose of cleaner. Furthermore, the means for recognizing the dose of cleaner contain means for measuring the pH value.

### B. CROSS-REFERENCE TO RELATED APPLICATIONS

This application claims priority to German Patent Application No. 10-2006-047 969.6 filed Oct. 11, 2006, which is hereby incorporated by reference in its entirety.

### C.-E.

Not Applicable

### F. BACKGROUND

The invention concerns a device for preparation and dispensing of beverages and a method for cleaning of a beverage dispensing device.

Such devices and methods are already known from EP 13 82 281 B1. In this document, an automatic beverage dispensing machine is disclosed, with a device for initiating and carrying out a cleaning process with a water-based cleaning fluid. To carry out the cleaning, a cleaner is added to a water-based cleaning fluid. In order to verify the correct addition of cleaner, a corresponding measuring device is arranged downstream from a steeping appliance. This measuring device measures the conductability or electrical resistance of the cleaning fluid and in this way determines whether the cleaner has been correctly added to the cleaning fluid.

Since the conductance measurement is based on the measurement of ionizable dissolved substances in the water-based cleaning fluid, it is extremely difficult to obtain an exact measurement of conductance, due to the regionally differing water hardness values. In order to still obtain satisfactory results in this regard, it is necessary to regularly calibrate the automatic beverage dispenser disclosed in this document to a new reference point in regard to water hardness, so that the presence of the cleaner in the water-based cleaning fluid can be properly measured. On the whole, a continuous monitoring of the reference point for the conductability measurement is necessary, which makes the automatic beverage dispenser more costly on the whole, more prone to malfunction and more in need of maintenance.

Furthermore, due to the inaccurate measurement (of conductance), it is possible that residues of the water-based cleaning fluid will still remain in the automatic beverage dispenser at the end of the cleaning process, because the measurement of the presence or absence of the cleaner was not done accurately enough. These residues significantly impair the taste and smell of the beverages. Only after a certain number of beverages have been dispensed are the lines flushed so much by the beverages themselves that an aftertaste or odor no longer occurs.

The problem of the present invention is therefore to provide an automatic beverage dispenser which eliminates the drawbacks of the prior art and furthermore enables a simple, economical and accurate checking for the adding of a cleaner.

### G. SUMMARY

This problem is solved according to the invention by a device and a method with the features of the claims.

Because the means for recognition of the dose contain means for measuring the pH value, the checking for the presence of a cleaner in a cleaning medium can take place much more precisely, since the pH value varies much less in dependence on the water hardness than does the value of the conductability. There is no time-consuming calculation of the dimensioning of the electrodes, as is the case when measuring the conductance.

Preferably, the means for supplying the cleaner contain a mixture container for the preparation of a cleaning medium. In this way, it is possible to prepare the cleaner in appropriate manner even before the actual cleaning, i.e., to dissolve it in the cleaning medium especially in appropriate concentration so that the cleaning can then commence with an optimally dosed cleaner.

Furthermore, the means for recognition of the dose of cleaner are arranged in the mixture container and/or downstream from the mixture container. Thanks to this arrangement, the dosing of the cleaner is possible directly in the mixture container before the feeding of the cleaning medium into the at least one line. A position of the means for recognition of the dose of cleaner downstream from the mixture container likewise enables a check as to whether a line has been filled completely with the cleaning medium.

If the mixture container is advantageously interchangeable, it is possible for the user of the device for preparation and dispensing of beverages, for example, to start the cleaning process by inserting the mixture container. As an alternative, the user can also place the cleaner already in appropriate form into the mixture container, so that after the mixture container is put in place the cleaning process can start at once, if necessary after an appropriate preparation. This also eliminates additional lines which take the cleaner from another part of the device for preparation and dispensing of beverages to the corresponding lines for dispensing the beverages.

Furthermore, means for initiating the cleaning process are advantageously provided. These can comprises, for example, a control mechanism, which puts out a signal for starting and/or stopping the cleaning process, depending on whether it has previously been determined that the cleaner was added or not. This makes sure that no cleaning process is carried out without cleaner. Furthermore, a display mechanism can also be provided, which then asks for the adding of cleaning agents again. Furthermore, a manual and/or automatic inserting of a container for the cleaning can also start the cleaning process.

In advantageous manner, the means for initiating the cleaning process contain a sensor for recognition of the presence of the mixture container. In this way, when the mixture container is inserted, the sensor can put out a signal to start the cleaning process. The cleaning process will then be directly initiated by the presence of the mixture container.

Furthermore, the means for adding the cleaner for the cleaning contain a pump and/or changeover valve. In this way, the cleaning medium can be transported in simple manner. Furthermore, with the changeover valve, other regions of the at least one line can also be filled with the cleaning agent and the cleaning agent can be directly channeled across the changeover valve.

According to a preferred embodiment, the cleaner for carrying out the cleaning process can be added in tablet and/or powder and/or liquid form. Thus, the user has diverse options of using appropriate cleaners for an optimal cleaning.

In especially advantageous manner, the cleaning agent consists of an aqueous solution of the cleaner. This provides a simple and economical form of a cleaning agent for the cleaning.

In particular, it is moreover advantageous in that additional means for recognition of the dose of cleaner are arranged at one outlet for the beverage dispensing. This enables a checking whether all regions exposed to the cleaning agent have already been cleaned, and this also makes possible a checking of the concentration of the cleaning agent during and/or at the end of the cleaning process.

However, in order to completely remove the cleaning agent from the regions where it is received, it is advantageous that at least one line can be filled with a rinsing agent. This will generally prevent any impairment of the taste or odor in the beverages which are dispensed by the device for preparation and dispensing of beverages, since the residues of any cleaning agent still remaining in the at least one line will be removed by means of the rinsing agent.

Furthermore, it is advantageous that the rinsing agent is an aqueous liquid, especially water. If the cleaning agent consists of an aqueous solution, a practically residue-free removal of the cleaning agent is possible by means of the rinsing agent in the form of an aqueous liquid, since the cleaner is likewise dissolved in the rinsing agent and thus can be quickly and easily removed.

According to the method of the invention for cleaning a beverage dispenser with a cleaning agent, wherein the dose of cleaning agent is determined, the pH value of the cleaning agent is measured to determine the dose of cleaning agent. Thanks to the use of the pH measurement, the presence of the cleaner in the cleaning agent can be done much more precisely than in a conductance measurement, since the pH value varies much less in dependence on the water hardness than does the conductance. Furthermore, there is no time-consuming calculation of the dimensioning of the electrodes, as would be required when measuring the conductance.

Furthermore, according to the invented method, the cleaning agent is prepared in a mixture container and the dose of the cleaning agent is measured at least once in the mixture container and/or downstream from the mixture container. Thus, the dose of cleaning agent can be monitored both at the start and also downstream in the regions being filled with the cleaning agent, thus making possible an effective and as brief as possible a cleaning time.

In advantageous manner, the starting and/or performing of the method is automatic or manual. In this way, either the user himself can start the cleaning process, if unusual circumstances result in a greater need for cleaning, or the cleaning process and/or parts of the individual cleaning process can be done automatically at regular intervals in absence of the user, for example, at night, without the occurrence of maintenance periods during daily usage when the machine is unavailable for dispensing of beverages.

It is especially advantageous when the starting of the method occurs by the inserting of the mixture container and/or the ending of the method by removal of the mixture container. In this way, it is easy to start and stop the cleaning method. Furthermore, any residues of the cleaning agent in the mixture container will also be removed by the inserting and subsequent removal of the mixture container.

Advantageously, the method involves a filling of the line with a rinsing agent, before and/or after the filling with the cleaning agent, so that the cleaning agent can be completely removed from the lines by the rinsing agent.

So that the dosage of the cleaner in the cleaning agent can be monitored continually, the dose of cleaner is measured before and/or during the filling with cleaning agent.

It is especially advantageous to measure the pH value at least once during the filling with the rinsing agent, in order to determine whether the cleaning agent has been totally removed from the regions filled with it.

To end the method, it is advantageous to stop the cleaning method manually and/or automatically after reaching a particular pH value. This ensures that the cleaning method is carried out as briefly and effectively as possible; thus, maintenance time during which beverages cannot be dispensed are held to a minimum.

Additional features and benefits of the present invention will emerge from the following description of a sample embodiment by means of the drawing, showing a coffee machine as the device for preparation and dispensing of beverages, with a mechanism for initiating and carrying out a cleaning process.

### H. BRIEF DESCRIPTION OF THE DRAWINGS

This shows:

FIG. 1, a device according to the invention in the form of a coffee machine, containing a changeover valve for the cleaning;

FIG. 2, a device according to the invention in the form of a coffee machine, containing a cleaning adapter for the cleaning;

FIG. 3, a device according to the invention in the form of a coffee machine, containing a cleaning container for the cleaning.

### I. DETAILED DESCRIPTION

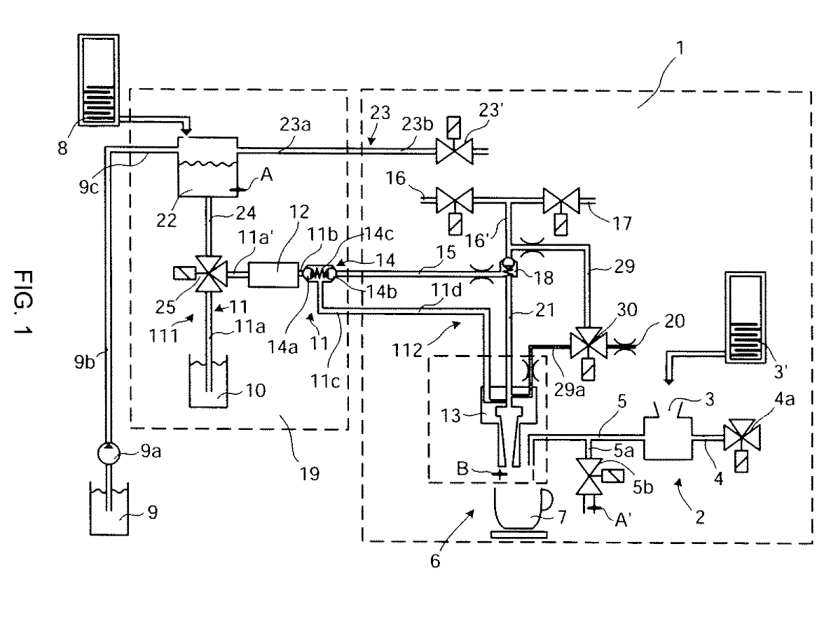

In the drawings at FIGS. 1 to 3, at the right side there is shown a large region enclosed by broken lines, indicating a coffee machine 1, having at its lower right side a brewing assembly 2 with a coffee feed 3 and a hot water feed 4. From here, the brewed coffee is taken by means of a coffee line 5 to an outlet 6 and from there it goes into a coffee cup 7 placed underneath the outlet 6.

Another important component of the coffee machine is a device for the preparing and dispensing of milk, where milk kept in a storage container 10 is transported by a pump 12 via a milk line 11 to a milk chamber 13, likewise provided in the region of the outlet 6 of the coffee machine 1 above the coffee cup 7. The milk line 11 in the embodiment of FIG. 1 is basically divided into five segments, namely, the segment 11a, which is arranged between the milk storage container 10 and a changeover valve 25 for the cleaning, the segment 11a′, which is arranged between changeover valve 25 and the pump 12, the segment 11b, which is arranged between the pump 12 and a rinsing line connection 14, to be described in greater detail hereafter, the segment 11c, which is arranged between the rinsing line connection and a refrigeration boundary also to be described in further detail hereafter, and the segment 11d, which is arranged between the refrigeration boundary and the milk mixing chamber 13.

The rinsing line connection 14 connects the milk line 11 to a rinsing line 15, which is connected to a cold water supply 16 and a steam supply 17, so that cold water or steam can be used as the rinsing medium. The rinsing line connection 14 is configured as a dual-action check valve with two ball-shaped valve bodies 14a, 14b and with a pretensioned spring 4c, forcing both valve bodies against the inlets of the connected milk line 11b or the rinsing line 15. If the milk pump 12 is activated, the valve body 14a blocking the milk line 11b is pushed away against the force of the spring and opens up the milk line 11c, 11d, so that the milk can flow across the segments 11c, 11d into the milk mixing chamber 13.

In similar fashion, the cold water feed 16 and steam feed 17 via a line segment 16′ means that the check valve 18 opens up the path of the cold water or the steam to the rinsing line 15, so that a rinsing agent can enter the rinsing line 15. After this, the valve body 14b blocking the rinsing line 15 is forced inward against the spring force of the spring element 14c and the rinsing agent can flow via the segments 11c, 11d of the milk line 11 into the milk mixing chamber 13 and rinse both this and the milk line segments 11c, 11d.

The left rectangle 19 indicated by broken lines represents a refrigerated region, especially a refrigerator, which basically surrounds and cools the milk storage container 10, the line segments 11a, 11a′, 24, the pump 12, the changeover valve 25, the rinsing line connection 14, as well as valve bodies 14a and 14b and spring 14c, and the mixture container 22, besides a pH sensor A and the line segments 9c, 23a. In this way, the milk is kept at a low temperature in the refrigerated region, so that the formation of lactic acid or casein is inhibited.

In order to also effectively clean the uncooled regions 112 of the milk line 11, a milk cleaner container 9 is provided, which need not necessarily be arranged in the refrigerated region 19. By means of a pump 9a, the milk cleaner is transported by line segments 9b and 9c to the mixture container 22; if necessary, a tablet magazine 9 can also be used in place of the milk cleaner container 9. Tablets of the tablet magazine are then individually placed into the mixture container 22. Since the milk cleaner 9 or the tablets of the tablet magazine 8 usually contain the milk cleaner in concentrated form, a cold water line 23 is also connected to the mixture container 22. If the cleaning process is started, cold water is supplied via the cleaning valve 23′ across the cold water line 23 with an uncooled line segment 23b and a cooled line segment 23a to the mixture container 22, so that the preparation of the cleaning agent can be undertaken in the mixture container 22.

Furthermore, an air feed 20 is provided. The air feed 20 fills two line segments 29, 29a with air across a valve 30. The line segment 29 emerges into the line segment 16′. The check valve 18 then opens up the path of the air into the rinsing line 15 and thereafter into the line segments 11c, 11d.

The line segment 29a, on the other hand, emerges in the region of the milk mixing chamber 13 upstream from the emergence of the line segment 11d into a line segment 21 situated downstream from the check valve 18, which is directly connected to the check valve 18 and empties into the milk mixing chamber 13.

The air feed 20 or thereafter the line segments 29, 29a serve to blow out the milk mixing chamber 13 and the rinsing line 15, the rinsing line connection 14, and the segments 11c, 11d of the milk line 11.

For determining the correct dose of the milk cleaner, a pH sensor A is arranged at the mixture container 22 in FIG. 1. This measures the pH value of the cleaning agent prepared in the mixture container 22 and sends a signal directly or indirectly to a control mechanism, which controls the cold water supply via the valve 23′ and the supply of cleaner of the milk cleaner by the delivery pump 9a. The pH sensor A checks for the presence of the cleaning agent and then sends a signal either to the user or to a corresponding control mechanism if the cold water and the milk cleaner have been dispensed in the correct ratio in the mixture container 22 to continue or interrupt the cleaning process. When basic cleaners are used, the cleaning process is continued if the pH value is above 10, especially above 11, and when acidic cleaners are used if the pH value is below 4, especially below 3.

Now, if the cleaning process is continued, the changeover valve 25 will be activated so that the line region 11a, which lies between the milk storage container 10 and the changeover valve 25, is interrupted and in its place the connection region 24 is connected indirectly via the changeover valve 25 and the line region 11a′ to the pump 12. Now, once the pump 12 is activated in similar manner, the cleaning agent located in the mixture container 22 will be delivered via the line segment 24, the changeover valve 25, and the line segment 11a′. In turn, when the pump 12 is activated, the blocking valve body 14a is forced away against the spring force of the spring 14c and opens up the line segments 11c and 11d, so that the cleaning agent can flow into the milk mixing chamber 13 via the fine segments 11c, 11d.

In order to check whether the cleaning agent has filled all line segments, an additional pH sensor B can be arranged at the outlet 6 of the coffee machine 1. In this case, the measured values of the pH sensors A, B can then be compared. If the measured values of the pH sensors A, B lie in the same given range, it can be assumed that nearly all contaminants have been dissolved in the cleaning agent and transported away.

Now, in order to flush the cleaning agent itself back out of the line regions 24, 11a′, 11b, 11c, 11d and the milk mixing chamber 13 that have been filled with it, so that there is no impairment of the taste by the cleaning agent in the coffee being dispensed, a rinsing process is now started. Now, no more additional cleaner is supplied from the cleaner container 9 via the pump 9a in the mixture container 22, but instead the mixture container 22 is filled with additional cold water via the cold water valve 23′ and the cold water line 23. Cold water as the rinsing agent is now supplied into the mixture container 22 and the line regions 24, 11a′, 11b, 11c, 11d, 13 are filled with the rinsing agent until the pH sensor A arranged at the mixture container 22 measures a pH value in the region of 7.

To check whether the cleaning agent was also entirely removed from the line regions 24, 11a′, 11b, 11c, 11d and the milk mixing chamber 13 with no residues, the pH sensor B arranged at the milk mixing chamber 13 or at the outlet 6 can be used once again. This measures the pH value of the rinsing agent at least once. Now, if both pH sensors A, B show a pH value in the region of 7, the rinsing process is ended, as is the cleaning process as a whole, since now the cleaning agent as well as the impurities have been flushed without a trace from the corresponding regions tilled with the cleaning agent and the rinsing agent. The coffee machine is now available once again to dispense coffee and/or milk.

It also lies within the context of the invention not to limit such a cleaning to the areas tilled with milk, but rather such a cleaning can also be used for the areas tilled with coffee in the coffee machine 1.

The basic cleaning cycle is similar to the already described cycle for the areas filled with milk. At the region of the coffee machine 1 filled with coffee, the cleaner, which can be in fluid, solid, or tablet form, is supplied to the brewing assembly 2 via the coffee feed 3, for example, through a tablet magazine 3′. After this, hot water is introduced through a brewing valve 4a via the hot water feed 4 into the brewing assembly 2 and the cleaner is prepared. The cleaning is then continued and the presence of the cleaning agent is checked by means of another pH sensor A′ by measuring the pH value of the cleaning agent. When a basic cleaner is present, the cleaning process is continued if the pH value is above 10, especially above 11; if an acid cleaner is present, it is continued if the pH value is below 4, especially below 3.

However, it also lies in the context of the invention to provide other threshold values of pH for the presence of the cleaner with cleaning agent. So that the pH sensor A′ does not get fouled with coffee and/or milk during the normal usage of the coffee machine, i.e., when no cleaning process is being carried out, it can be arranged in a branch line 5a fitted with a valve 5b downstream from the brewing assembly 2. The valve 5b is then opened only during the cleaning process. Similarly to the above described method, another pH sensor (not shown) can also be arranged at the outlet of the coffee line 5 and measure the pH value at least once during the filling of the coffee line 5 with the cleaning agent. If the measured pH value of the pH sensor located at the outlet of the coffee line no longer changes as compared to the measurement of the pH value by the pH sensor A′, the cleaning process is interrupted. After this, the coffee line 5 and the brewing assembly 2 and also possibly the branch line 5a are flushed with hot water until the pH sensor A′ and/or the possible second pH sensor arranged at the end of the coffee line 5 indicate a pH value in the region of 7. The valve 5b is then closed and the cleaning and rinsing process as a whole is finished.

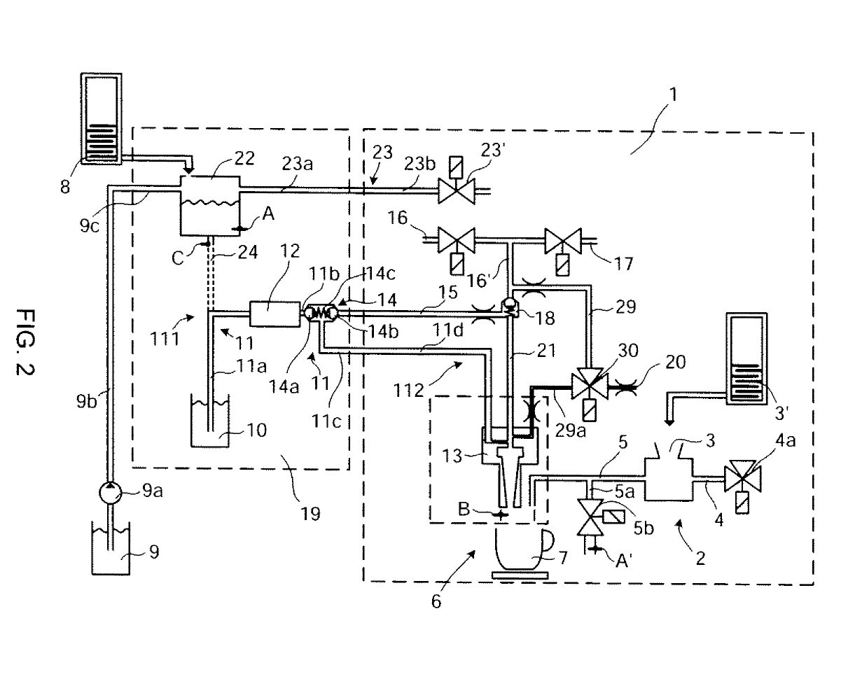

FIG. 2 shows another embodiment of a device for preparation and dispensing of beverages in the form of a coffee machine. The region of the coffee machine 1 is similar in construction to that in FIG. 1. But in the refrigerated region 19, instead of the changeover valve 25, there is arranged a removable line 11a or 24. In order to prepare the cleaning process, the line 11a is removed from the milk supply container 10 and hooked up to the mixture container 22 via the line piece now designated as 24. A sensor or switch C arranged on the line 24 and/or a mixture container 22 recognizes the presence of the line 24 and sends a signal to initiate the cleaning process. The cleaning process now runs basically the same as that described for FIG. 1. Only at the end of the cleaning process, instead of switching the changeover valve 25, the line 24 is removed and again connected to the milk container 10 as the line segment 11a. Thus, the pump 12 can again draw in milk from the milk supply container 10 through the line segments 11a, 11a′.

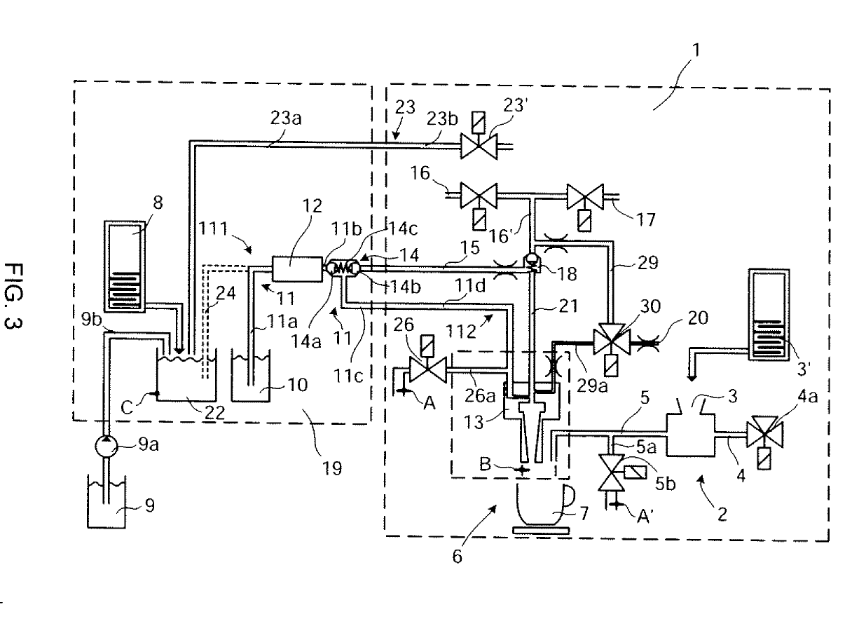

FIG. 3 shows a third device according to the invention for preparation and dispensing of beverages in the form of a coffee machine 1. In contrast with the embodiments of FIGS. 1 and 2, here the milk container 10 is interchangeable. To initiate the cleaning process, the milk supply container 10 is taken out and replaced by the mixture container 22. A sensor or switch C recognizes the presence or replacement of the milk supply container 10 by the mixture container 22. Once the mixture container 22 is installed, the cleaning process is started. The cleaning and subsequent rinsing takes place similar to the cleaning and rinsing process as described in FIG. 1. When the rinsing process as a whole is completed, that is, the pH sensor A and/or the pH sensor B measure a pH value in the range of around 7, the mixture container 22 is removed and the milk supply container 10 is put back. The removing and installing here can be done both manually through a switch or also automatically by means of a sensor C.

Furthermore, the respective pH sensors A, A′ and B can be arranged via a branch line 26a with a valve 26 in series, so that the pH sensor A, A′, B is not fouled with milk and/or coffee during the normal operation of the coffee machine. The branch line 26a is opened only during the cleaning and rinsing process.

As another option of feeding a cleaner for cleaning to the mixture container 22 or the brewing assembly 2, a tablet magazine 8, 3′ to supply the cleaner in tablet form can be arranged in all of the embodiments.

In summary, the present invention offers the benefit that the cleaner in the cleaning agent can be dispensed exactly by means of the pH measurement and both the filling with the cleaning agent and the removal of the cleaning agent from the at least one line can occur fast and accurately.

1. A device for preparation and dispensing of beverages comprising: a mechanism for initiating and carrying out a cleaning process, comprising at least one line that serves to transport the beverages to a beverage outlet, means for adding a cleaner; for at least partial cleaning of the at least one line, and means for recognizing a dose of cleaner,
wherein the means for recognizing a dose of cleaner comprises means for measuring a pH value associated with the cleaner.

2. The device of claim 1, wherein the means for adding a cleaner comprises a mixture container for the preparation of a cleaning medium.

3. The device of claim 2, wherein the means for recognition of the dose of cleaner are positioned in one or more of the following locations:
in the mixture container; and
downstream from the mixture container.

4. The device of claim 2, wherein the mixture container is interchangeable.

5. The device of claim 1, wherein the mechanism for initiating the cleaning process is provided

6. The device of claim 1, wherein the means for initiating the cleaning process comprises a sensor for recognizing the mixture container.

7. The device of claim 1, wherein the means for adding the cleaner comprises one or more of a pump and a changeover valve.

8. The device of claim 1, wherein the cleaner is one or more of a tablet, a powder and a liquid.

9. The device of claim 1, wherein a cleaning agent comprises an aqueous solution of the cleaner.

10. The device of claim 1, wherein means for recognizing the dose of cleaner are located at a beverage dispensing outlet.

11. The device of claim 2, wherein the mixture container is located in a refrigerated region.

12. The device of claim 1, wherein at least one line can be filled with a rinsing agent.

13. The device of claim 12, wherein the rinsing agent is an aqueous liquid.

14. A method for cleaning a beverage dispenser with a cleaning agent, wherein the method comprises determining a dose of the cleaning agent by measuring a pH value of the cleaning agent.

15. The method of claim 14, comprising
preparing the cleaning agent in a mixture container; and
measuring the dose of cleaning agent at least once in one or more of the mixture container and downstream from the mixture container.

16. The method of claim 14, wherein determining a dose is performed automatically.

17. The method of claim 14, the starting of the method occurs by the inserting of the mixture container (22) and/or the ending of the method occurs by removal of the mixture container (22).

18. The method of claim 14, further comprising one or more of the following:
filing a line with a rinsing agent before filing the line with the cleaning agent; and
filing a line with a rinsing agent after filing the line with the cleaning agent.

19. The method of claim 14, wherein measuring a pH value comprises one or more of measuring the dose before a line is filled and measuring the dose while a line is filled.

20. The method of claim 18, wherein measuring a pH value comprises measuring the pH value it least once while a line is filled with a rinsing agent.

21. The method of claim 14, wherein the method is manually stopped after reaching a particular pH value.

22. The method of claim 14, wherein determining a dose is performed manually.

23. The method of claim 14, wherein the method is automatically stopped after reaching a particular pH value.
